(19) United States
(12) Patent Application Publication
(10) Pub. No.: US 2024/0324598 A1
(43) Pub. Date: Oct. 3, 2024

(54) System, Method and Compositions for Stemming Plant and Animal Decay and Contamination from Aerobic Pests, Bacteria, Viruses, and other Organisms

(71) Applicants: Mark Porzilli, Roxbury, CT (US); Samuel P. Laufer, Roxbury, CT (US)

(72) Inventors: Mark Porzilli, Roxbury, CT (US); Samuel P. Laufer, Roxbury, CT (US)

(21) Appl. No.: 18/434,073

(22) Filed: Feb. 6, 2024

Related U.S. Application Data
(60) Provisional application No. 63/443,536, filed on Feb. 6, 2023.

(51) Int. Cl. A01N 59/04; A01N 3/00; A01N 25/02; A01P 1/00; A23B 7/157

(52) U.S. Cl. CPC A01N 59/04; A01N 3/00; A01N 25/02; A01P 1/00; A23B 7/157

(57) ABSTRACT

A method for sterilizing a live plant in a safe and effective manner using reverse respiration comprising the step of: submerging the live plant in a tank that includes a carbonated aqueous solution for a predefined period of time resulting in destruction of any present pathogens by a reverse respiration process in which oxygen is denied to the pathogens during a CO2 cycle of the live plant.

### CROSS-REFERENCE TO RELATED PATENT APPLICATIONS

This application is based on and claims priority to U.S. Provisional Patent Application No. 63/443,536, filed Feb. 6, 2023, the entire contents of which is incorporated by reference herein as if expressly set forth in its respective entirety herein.

### TECHNICAL FIELD

The present disclosure is generally directed to sterilization and cleaning of live plants, produce and other live matter; and more particularly, is directed to a system, method and compositions for stemming plant and animal decay and contamination from aerobic pests Virus' and other organisms and bacteria utilizing a reverse respiration technique. Inorganic materials may be similarly disinfected by this method without any environmental contamination or filtration requirements. Inorganic materials may also be protected from oxidative corrosion without subsequent residue cleaning requirements.

### BACKGROUND

Live vegetation not only provides humans with food but is used in many different other settings such as terrestrial and aquatic live plants. For example, maintaining an aquarium is one of the most common hobbies and fish are among the most popular pets in the world. In establishing an aesthetically pleasing and realistic aquatic environment, live aquatic plants are often used. Unfortunately, aquatic plants can suffer from pests and disease which can potentially harm the fish.

Similarly, the number one source of food poisoning in the developed world is fresh produce. This is mostly due to post-production washing being deeply inadequate, leaving infected fecal matter of people and animals behind. In the United States, bagged salad greens are the most dangerous source of listeria, salmonella and E-coli.

There is therefore a need for a system and method for the sterilization, cleaning of live plants, produce and other live and inanimate matter in a safe and effective manner. The deactivation of microbes and absence of oxygen additionally acts as a preservative and decay retardant for produce, food and other organic materials.

### SUMMARY

A method for sterilizing a live plant in a safe and effective manner using reverse respiration comprising the step of: submerging the live plant in a tank that includes a carbonated aqueous solution for a predefined period of time resulting in destruction of any present pathogens by a reverse respiration process in which oxygen is denied to the pathogens during a CO2 cycle of the live plant.

### BRIEF DESCRIPTION OF THE DRAWING FIGURES

FIG. 1 is a side elevation of a reverse respiration system according to a first embodiment showing treatment of an aquatic plant;

FIG. 2 is a side elevation of a reverse respiration system according to a second embodiment showing treatment of an aquatic plant;

FIG. 3 is a side elevation of a reverse respiration system according to the first embodiment showing treatment of a vegetable; and

FIG. 4 is a perspective view of an industrial reverse respiration system.

### DETAILED DESCRIPTION OF CERTAIN EMBODIMENTS

The present disclosure is generally directed to sterilization and cleaning of live plants, produce and other live matter; and more particularly, is directed to a system, method and compositions for stemming plant and animal decay and contamination from aerobic pests and bacteria utilizing a reverse respiration technique.

### Reverse Respiration

Reverse respiration is a process for sterilization (disinfection) of live plants, fruits and vegetables which exploits differences in how insects, bacteria and parasites respire with respect to plants. One primary advantage of reverse respiration is that it is 100% non-toxic, leaves zero residue, requires no rinsing, and has excellent efficacy.

### Sterilization/Disinfection System

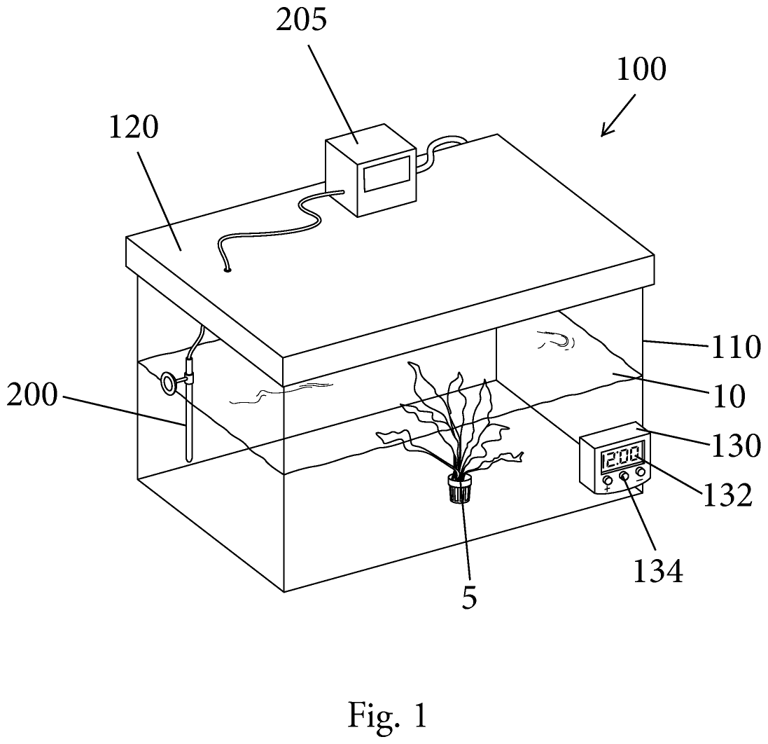

Now turning to FIG. 1, one exemplary system 100 is disclosed.

### Tank 110

The system 100 includes a tank or container 110. The tank 110 is configured to hold a predetermined volume of liquid (e.g., the tank holds a predefined number of gallons). The size and shape of the tank 110 can vary and is selected in view of the objects to be treated. For example, if the system 100 is primarily intended to treat aquatic plants, then the size of the tank 110 is selected in view of the size of the aquatic plants. The tank size is selected so that the one or more objects to be treated are fully submersed in the liquid within the tank 110. The tank 110 can be formed of any number of materials, such as plastic or glass, and is preferably transparent to allow the user to view the one or more objects to be treated.

The tank 110 has an open top and includes a cover or lid 120 that is placed over the open top to cover at least part of the opening or cover the entire opening so long as in both instances, the cover does not form an airtight seal with the tank 110. The cover 120 can take any number of different forms including a membrane that permits a certain amount of gas diffusion.

### Timer 130

In addition, the system 100 can include a timer 130 that is mounted along the tank 110 to provide the user with time related information. For example, the timer 130 includes a battery that powers a processor and includes an LED screen 132 on which time related information is displayed. Also, the timer 130 includes one or more inputs to allow the user to input information. For example, the timer 130 can include one or more buttons 134 that allow the user to input information. The timer 130 can act as a countdown timer to allow the user to input a set time period, such as 24 hours or 30 minutes, and then the timer 130 can display the countdown to 0. When the timer 130 reaches 0, an alert can be generated. The alert can be visual and/or auditory. In addition, the timer 130 can be of a type that includes a transmitter to send the alert over a network to a computing device, such as a smart phone.

Treatment solution 10

In one embodiment, the treatment of the one or more objects is performed with a treatment solution, generally shown at 10, that is disposed within the tank 110.

The treatment solution is a CO2 solution and more particularly, can be carbonated water (CO2 in water). Carbonated water is widely available on the market. For example, Seltzer water is a form of carbonated water. The tank 110 of FIG. 1 is designed to receive premixed carbonated water. The tank 110 can include one or more fill lines; however, the user would naturally fill tank 110 with enough carbonated water until the one or more objects are covered with the carbonated water.

As described herein, the treatment solution (e.g., water saturated with CO2) asphyxiates the parasites but does not affect the plants or produce (living matter) in any adverse manner. Carbon dioxide (CO2) is unstable in water such that in a matter of hours, it dissipates from the solution leaving nothing but plain water in its place. Thus, the byproduct of this treatment process is completely harmless and can easily be discarded as by pouring the spent treatment solution down the drain.

The units for measuring the amount of dissolved CO₂ are commonly stated as grams of CO₂ per liter of beverage (g/L) or as volumes of CO₂ (STP) per volume of liquid (vol/vol). The approximate conversion between these two units is 1 vol/vol being equal to ˜2 g/L*. The treatment solution preferably comprises a saturated solution of CO₂ in the water.

One carbonation technique is a forced carbonation method (described hereinbelow). The forced carbonation method is a technique that pumps pressurized CO₂ gas into a headspace or liquid inside of a pressurized vessel. CO₂ can be pumped through a porous stone submerged in water, forcing the CO₂ to come out as small bubbles that diffuse quickly into treatment solution. The carbonation process is complete once the equilibrium with partial pressure is reached between the treatment solution and the headspace.

When using a premixed treatment solution (e.g., carbonated water), the solution is typically provided in bottle or canister form with a sealed cap. The bottle would be a one-time use and is opened and then poured into the tank 110. Alternatively, in situ mixing can be done as described below.

### Measurement Device 200

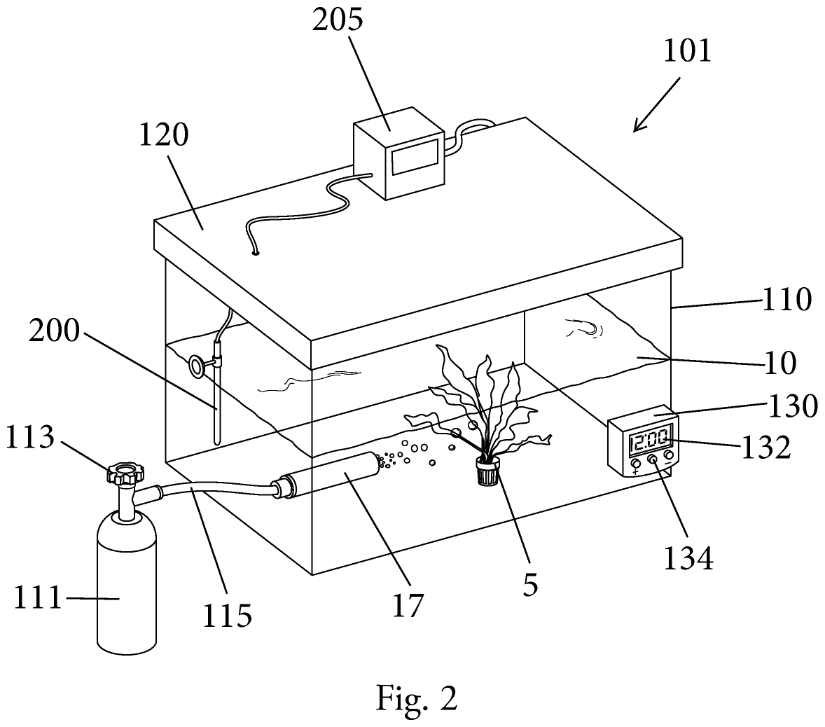

In one embodiment, the system 100 includes a measurement device 200. In one embodiment, the measurement device 200 comprise a CO2 measuring device that is configured to measure the CO2 level in the water. There are many different ways to measure CO2 in a solution, such as the present treatment solution. For example, a CO2 measurement probe 200 can be used as shown in FIG. 2 or in another embodiment, a CO2 indicator kit can be used to monitor CO2 levels. The kit includes an indicator liquid, such as a 10 mL (0.34 fluid oz) CO2 indicator liquid, a CO2 indicator, and a color check sticker to help gauge CO2 levels. When the CO2 measurement device 200 comprises a probe, it can be hung in the tank as shown in FIG. 2, as by using a suction cup clip that attaches to one wall of the tank 110. The measuring portion of the probe should be located at a proper location, such as in the bottom ½ of the tank as opposed to be at or near the top surface. The probe itself can be attached as by a wire to an external control unit 205 that can include a display (LCD display) that can display the current measured CO2 level. The external control unit 205 can be designed so that it can be programmed with an acceptable range of the CO2 level and when the observed CO2 level is within this range, an indicator is displayed to the user, such as a light or message on the display.

The CO2 measurement device 200 can be used to monitor the CO2 level in the tank and can be in communication with a master controller in some embodiments.

In another embodiment, the measurement device 200 comprises a pH meter that is configured to measure pH of the treatment solution. PH level is indicative of the CO2 level since as CO2 is introduced into water, the pH lowers. Generally, tap water has a pH near 7. In one embodiment, the CO2 is added to the water until the measured pH is between 3 and 4 which is a level suitable for the reverse respiration treatment.

### Tank Accessories

When the tank 110 is intended and configured for use with aquatic plants, a plant retainer accessory can be provided. This accessory can be a plate structure for placement on floor of the tank 110 and can include one or more integral plant retainer clips, such as upstanding C-shaped clips that can be used to hold the stem of the live plant to prevent it from floating to the surface (i.e., when the live plant does not include a pot).

Alternatively, the floor of the tank 110 itself can include these integral plant retainer clips.

### Alternative System 101

FIG. 2 illustrates a system 101 that is very similar to system 100 and therefore, like elements are numbered alike. The system 101 includes the tank 110 and the main difference between the two systems is that the system 101 is configured to form the treatment solution in situ. In particular, instead of adding premixed treatment solution (i.e., carbonated water), the system 101 is configured to generate the carbonated water in tank 110.

System 101 includes a source of CO2 111. This source can be in the form of a gas canister that has a valve 113 and an inlet line 115 that is in fluid communication with the inside of the tank 110. For example, a nozzle 117 can be provided within the tank 110 and in fluid communication with the inlet line 115 to introduce CO2 into the tank 110. In this embodiment, the user fills the tank with water and then introduces CO2 gas into the water within the tank 110 until a saturated CO2 solution is formed.

A master controller (not shown) can be provided and is operatively connected to valve 113 and also can be in communication with the CO2/pH measurement device 200 to control the flow rate and amount of CO2 that is added to the water in the tank 110. This master controller ensures that the water is properly saturated and the desired CO2 level is reached.

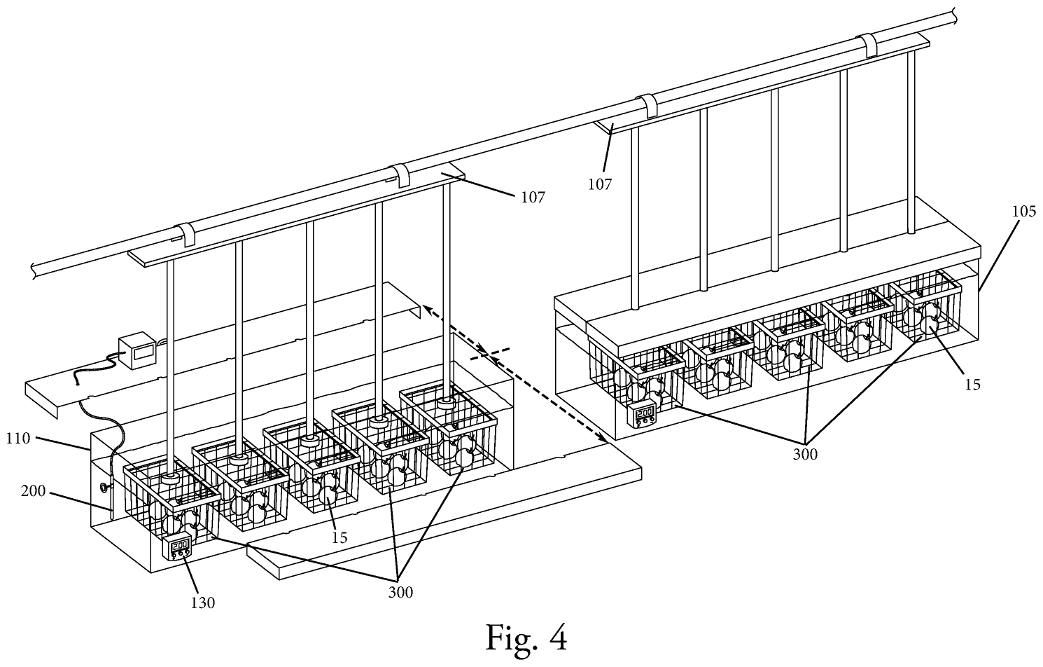

For example, in a commercial setting such as FIG. 4, the tank 110 can be a large tank or vat and can include a water inlet with controllable valve and a water level sensor or other sensor, like a flow sensor, that allows the total volume of water that was added to the tank 110 to be calculated. The controllable valve is in communication with the master controller via traditional communications protocol, such as Wi-Fi, etc.

In the commercial tank 110 setting, after the water is added, the CO2 valve is opened and CO2 is added to the water until the desired amount of CO2 is reached as evidenced by at least one measured value, such as pH or CO2 level. For example, CO2 can be added until the observed pH of the treatment solution is between 3-4. Once, the desired amount of CO2 is observed, the CO2 flow is stopped and the timer 130 can automatically start to reflect the total time of the reverse respiration process that is occurring in the tank 110.

In a commercial setting, such as that shown in FIG. 4, this entire process can be automated by the master controller.

It will also be appreciated that the live plants can be placed in one or more baskets 300 that are lowered into the tank 110 and thus, once the CO2 phase of the reverse respiration process is completed, the one or more baskets 300 can be raised and then moved, in an automated manner, to a rinse tank 105 (pure water) in which the basket is lowered to perform the O2 phase of the reverse respiration process. A robotic transporter 107 can be used to move the basket from one tank to another tank. The basket is enclosed in order to keep the contents submerged as the CO2 solution will make most content highly buoyant.

### Exemplary Treatment Applications

The following three scenarios represent different applications where Reverse Respiration may be used to great effect is the disinfection of plants, the disinfection of produce, and as an algicide.

### Live Plants (Terrestrial and Aquatic)

As mentioned, reverse respiration has particular utility in disinfecting aquatic plants 5. In the aquatics industry, live plants are chronically infested with worms, insects, larvae, eggs, viruses, and bacteria. In order to not infect entire aquatic systems, live plants are disinfected with chemicals like bleach and other caustic poisons. This has historically been only partially successful. In addition, poisons are notoriously difficult to remove. The primary disadvantage of caustic chemical disinfection is that if even minute amounts of disinfectant exist, entire tanks or lots of fish and animals can be poisoned.

However, all of these pathogens respire oxygen (O2), but plants respire CO2. As there is no oxygen in the treatment solution, the parasites are eliminated, but the plants flourish. Upon evaporation, the CO2 dissipates, leaving plain water, so no residue occurs.

The reverse respiration treatment eliminates 100% of pathogens and holds zero risk of poisoning. As discussed herein, the reverse respiration treatment can eliminate pests in less treatment time (e.g., 30 minutes or more) than elimination of algae (5 hrs. or more).

Applicant is aware of only three known microbe types which can survive in the reverse respiration solution (i.e., the treatment solution). One is lactic-acid based bacteria, largely common to highly specific dairy processes, and the other, acetic acid based found in fermentation and wines. And lastly, yeasts. None of these are found in produce, terrestrial plants or aquatic plants, nor are any considered pathogenic towards humans.

### Produce 15

As mentioned, the number one source of food poisoning in the developed world is fresh produce. This is mostly due to post-production washing being deeply inadequate, leaving infected fecal matter of people and animals behind. In the United States, bagged salad greens are the most dangerous source of listeria, salmonella and E-coli. None of these pathogens can survive in the CO2 solution (i.e., the treatment solution).

Produce soaked in the CO2 solution will be insect, virus, and bacteria free in under 30 minutes. Rinsing is desirable to remove particulate matter, but it is not required. No rinsing or washing is required, as no residue exists.

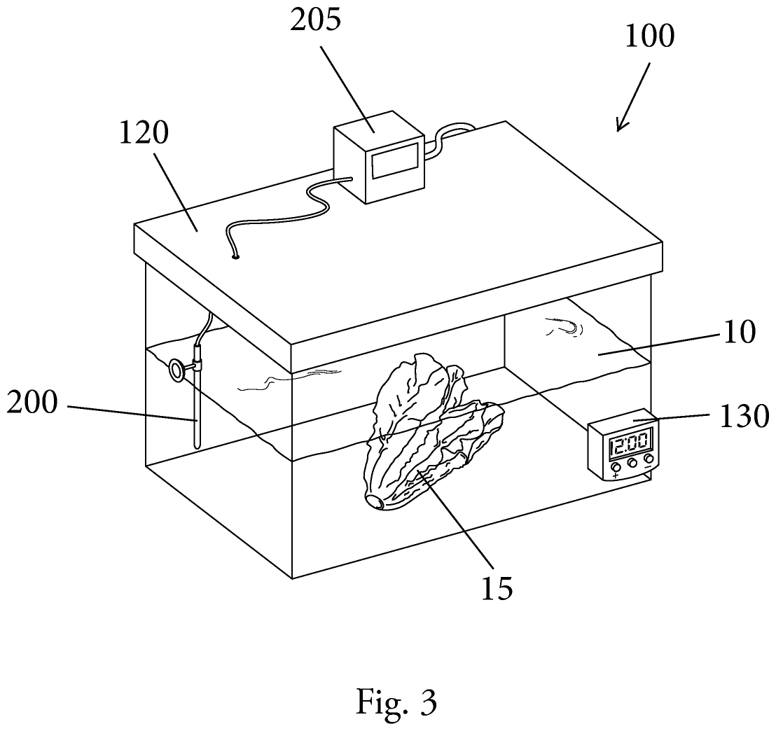

FIG. 3 shows the treatment of produce 15 in that FIG. 3 shows a head of lettuce submerged within the carbonated water in the tank 110.

It will be appreciated that the system is thus configured to treat other types of produce and in particular, any plant based vegetable or other living matter, can be submerged into the treatment solution.

As previously mentioned, in a commercial setting, there can be a CO2 treatment tank, an oxygenation (O2) tank, a drying station and a packing station. For example, many items of produce can be submerged in the CO2 treatment tank (e.g., using a basket lowered into carbonated water) and once the CO2 treatment phase is completed, these items of produce are placed in an oxygenation tank (i.e., pure water and no CO2) and then are brought to a controlled drying station. Once dried, the items are packaged in a way by which the oxygen level is reduced (as by adding an inert gas).

### Algicide

When an algae-infested object (plants, rocks, ornaments, etc.) is soaked in the CO2 solution for greater than or equal to 5 hours, it removes the magnesium from the algae, killing it. Algae is considered unsightly in the aquarium hobby but it can also be fatally detrimental to the local ecosystem or biotope. Algae can suffocate the desired, live plants, rob them of vital nutrients and block life-giving light sources. Algicides are extremely limited in efficacy and are often highly toxic and as such, must be administered with extreme care. Algicides can be particularly toxic and intolerable to invertebrates. The reverse respiration CO2 solution (treatment solution), unlike other algicides, has zero toxicity and leaves no chemical residue once the treatment is completed.

It will be understood from the aforementioned paragraph that the system and treatment method described herein is thus not limited to treatment of a living, plant-based object but can also be used for inanimate objects as well that are contaminated with algae, insect larvae and bacteria, etc.

### Ancillary Advantages

All plants—terrestrial, aquatic, or vegetables—have air spaces throughout the plant, but especially in the leaves. In addition, all green plants contain chlorophyll.

Reverse respiration fills the air spaces with sterilized water, making fruits and vegetables ‘feel’ fresher, crisper, and 10%-20% heavier than they did prior to being soaked. In addition, the intense CO2 content ‘charges’ the chlorophyll in greens making them a bright, deep green which intensifies their natural flavors.

Typically, some plant damage is inevitable with sterilization. However, unlike all known plant sterilization methods in common use, no damage was observed either empirically or via microscopic inspection. In contrast, with live plants, the Applicant observed accelerated growth after a reverse respiration treatment which lasted for several weeks following treatment.

### High Pressure Penetration

The CO2 solution has several unique properties that gives it access to often inaccessible regions.

Ticks for example have the ability to use stored oxygen in their blood for extended periods. They are known to survive total submergence for many days for this reason.

An aquatic equivalent that we had the opportunity to test is the Malaysian Trumpet Snails. All snails have a ‘trap door’ known as the operculum which protects them from their environment and predators. The operculum normally offers limited protection against water contaminants or the air but in the case of the Malaysian Trumpet, the operculum is so robust, it can survive four days in pure bleach. Hobbyists generally concluded that no cleaning method kills Malaysian Trumpets. However, the CO2 solution proved to be a wholly different matter. Malaysian Trumpets were fully extinguished in only 30 minutes using the present treatment solution. This is because the CO2 solution has enormous pressure, even after opening a fresh bottle. It will typically hold an average of 300% atmospheric pressure for 4 days or so. This easily penetrated the snail's operculum, forcing all oxygen out of its bloodstream, extinguishing it. Also, no insect larvae survived as well. Powerful anecdotal evidence that ticks and similarly protected insects will not survive this intense pressure as well.

In addition to the advantages of unusually high-pressure gaining access to normally inaccessible areas, the CO2 solution is dynamic and not static. That is, it has several oscillatory frequencies which assist in deep penetration. A lower frequency that is basically the rate of bubbles escaping the solution and a much higher frequency which was found to penetrate even the most complex, congested and difficult to access areas of even the most deeply netted plants. The former frequency being infrasonic, circa 3 Hz but the latter being nominally 7000 Hz which behaved not unlike an ultrasonic cleaner. These oscillations in combination with the intense pressure improved the cleaning efficacy dramatically over all other sterilization methods tested.

### Potable Water

There are no known bacteria or virus' that can survive or replicate in the CO2 solution. As a result, it may be a superb vehicle for water purification that leaves no residue. In experimental tests, just 30 minutes of this level of carbonation disinfected the water to 100% purity. In hours, the CO2 dissipates, leaving pure water. This dissipation may be greatly accelerated to just minutes with stirring or heat. The addition of a common ultrasonic cleaning probe will remove 100% of the CO2 in seconds, leaving pure water.

Thus, for quantities of water that need to be purified, the untreated water can be added to a tank or portable storage device for treatment and then CO2 gas is introduced into the water to form a saturated CO2 water solution. Any particulate matter may be subsequently removed via filtration or straining.

### External Use

Another possibility is to generate CO2 in situ. A combination of sodium bicarbonate and citric acid once wet, will release enormous volumes of CO2. It has been postulated that this mixture could be spread amongst fields and farms to eliminate pests as its residue, sodium citrate is a common food additive, is fully biodegradable and is considered inert and non-toxic by the EPA. The CO2 will asphyxiate most if not all ground-based insects however winds and environmental interference will degrade the efficacy. In addition, the high-pressure advantage of the CO2 solution is not possible in free air which may limit its ability with certain insects.

It will be appreciated that this technique is different than the one described with respect to FIG. 2. In FIG. 2, the CO2 is stored in a tank, while the above process generates the CO2 from raw ingredients.

### Exemplary Treatment Method

In accordance with one treatment method, the tank 110 of FIG. 1 is filled to a predefined level with the treatment solution (e.g., carbonated water) and then the object to be treated, such as an aquatic plant, is prerinsed and then placed into and fully submerged in the treatment solution. Some aquatic plants have bottom pots which will weight them down properly; however, if the aquatic plant does not have a base weight, then an external weight can be used to weight the aquatic plant down. The cover 120 is then placed on the tank 110 and the timer 130 can be set for a predetermined treatment time depending upon the object to be cleaned. For example, the treatment time can be between 30 minutes and 12 hrs.; however, it will be appreciated that other treatment times are equally possible. It has been found that 30 minutes or more is sufficient for the treatment of pests, insects, eggs, etc., while a longer treatment time such as up to 12 hrs. is sufficient for algae destruction.

For example, for treatment of an aquatic plant, the treatment time can be at least 30 minutes and can be one or more hours. For example, in one application. the Applicant has treated aquatic plants for up to 12 hours in a dark environment to eliminate algae.

In the CO2 phase of treatment, darkness can increase effectiveness but is optional and not required.

Once the treatment period has lapsed (e.g., the timer reaches 0:00), the user can remove the treated aquatic plant and they can optionally be placed in a soaking tank that is filled with plain water in light conditions. If desired, the plant can be left in the soaking tank for a predetermined amount of time (e.g., 30 minutes) for aeration (however, usually, the tank is sufficiently oxygenated such that this step can be skipped). The O2 phase of treatment can thus include using an air stone in water to introduce air into the water (aeration). A final rinse can be performed and then the aquatic plant can be returned to the aquarium.

The present method thus can be characterized by its cycles of CO2 treatment in dark environment followed by placement in a light environment without CO2.

Reverse Respiration disinfects aquatic plants without chemicals or special equipment by simply alternating the CO2 levels in the water in cycles that favors plants but not pests.

Accordingly, the present system and method operates on the principle that plants require CO2 and O2 during their day and night cycles. Reverse respiration works by denying oxygen to pests during the CO2 cycle of the plants. So, with the plants immersed in a pure CO2 solution, they respire normally but all of the pests are asphyxiated. Then the next cycle is oxygenated, denying CO2 to any anaerobes. In both cases, when the plants desire CO2, we exclude O2, and the aerobic pests perish. When the plants desire O2, we exclude CO2, and the anaerobe pests perish. Upon completion some 12 hours later, there are no pests, no eggs, no algae, and the only residue is water.

With respect to aquatic plants, the present system and method thus is a chemical-free technique for the removal of worms, eggs, diatoms, insects and algae from aquatic plants in less than 24 hours without any residue. The reverse respiration process is a much gentler plant cleaning method compared to other chemical methods (e.g., it inflicted least damage to the cell contents, proteins, enzymes and chloroplasts, and did not slow or reduce vascular activity).

In addition, the treatment method can be carried out in dark environment, such as in a dark room or within a closed closet or within a larger outer housing.

### Ultrasonic Treatment

In one embodiment, in the O2 phase, an ultrasonic device is used to treat the carbonated water. The ultrasonic device emits high-frequency sound waves that create bubbles and vibrations in the water (known as the cavitation process. The high-frequency sound waves destroy the CO2 in the carbonated water, thereby converting the carbonated water into pure water. Thus, the CO2 phase can be ended and the O2 phase of treatment can be initiated by emitting the high-frequency sound waves within the carbonated water to reduce the CO2 and form pure water. This allows the CO2 phase to easily be terminated by converting all of the CO2. The ultrasonic device can be inserted into the tank and in industrial settings can be coupled to an automated transporter to move the ultrasonic device.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A method for sterilizing a live plant in a safe and effective manner using reverse respiration comprising the step of:
submerging the live plant in a tank that includes a carbonated aqueous solution for a predefined period of time resulting in destruction of any present pathogens by a reverse respiration process in which oxygen is denied to the pathogens during a CO2 cycle of the live plant.

2. The method of claim 1, wherein the live plant comprises an aquatic plant.

3. The method of claim 1, wherein the live plant comprises an item of produce.

4. The method of claim 1, wherein the carbonated aqueous solution comprises water saturated with CO2.

5. The method of claim 1, wherein the carbonated aqueous solution comprises between 6-8 grams per liter which equates to approximately 330% pCO2, where the resultant carbonated aqueous solution manifests a nominal pH of 3 to 4 and preferable 3 to 3.5.

6. The method of claim 1, wherein for a substantial amount of the predefined period of time in which the live plant is submerged, the tank is in a dark environment.

7. The method of claim 6, wherein the substantial amount is at least 95% of the predefined period of time.

8. The method of claim 6, wherein the substantial amount is at least 99% of the predefined period of time.

9. The method of claim 1, wherein the live plant comprises an aquatic plant and the predefined period of time comprises at least 30 minutes.

10. The method of claim 1, wherein the live plant comprises an aquatic plant and the predefined period of time is between 0.5 hours for disinfection and 12 hours for algicidal effects.

11. The method of claim 1, wherein the live plant comprises an item of produce and the predefined period of time comprises at least 30 minutes.

12. The method of claim 1, wherein the live plant comprises an item of produce and the predefined period of time is between 0.5 hours and 12 hours.

13. The method of claim 1, further comprising the step of removing the live plant from the tank after the predefined period of time has lapsed and placing the live plant in a tank of oxygenated water.

14. A method of sterilizing plant-based produce comprising the steps of:
performing a CO2 phase of a reverse respiration treatment process by submerging the plant-based produce in a first tank that includes a carbonated aqueous solution for a predefined period of time resulting in destruction of any present pathogens by the reverse respiration treatment process in which oxygen is denied to the pathogens during the CO2 phase; and
performing an O2 phase of the reverse respiration treatment process by removing the plant-based produce from the CO2 phase and subjecting the plant-based produce to an oxygenated environment.

15. The method of claim 14, wherein the plant-based product comprises fruits and/or vegetables.

16. The method of claim 14, wherein the step of performing the O2 phase of the reverse respiration treatment process comprises placing the plant-based product in a water tank that does not include CO2.

17. The method of claim 14, further including a robotic transporter including a basket in which the plant-based produce is placed and is configured to be lowered into the first tank and then moved to a second tank that is filled with water without CO2 to perform the O2 phase.

18. The method of claim 17, wherein the first tank includes a water inlet for injecting water into the first tank and a CO2 inlet for injecting CO2 gas into the first tank.

19. The method of claim 17, wherein the carbonated aqueous solution has a pH between 3 and 4.

20. The method of claim 14, further including the steps of: drying the plant-based produce after the O2 phase and packaging the dried plant-based produce.

21. The method of claim 14, wherein the CO2 phase is performed in a dark environment and the O2 phase is performed in a light environment.

22. A method for sterilizing a live plant in a safe and effective manner using reverse respiration comprising the steps of:
performing a CO2 phase of a reverse respiration treatment process by submerging the live plant in a tank that includes a carbonated aqueous solution for a predefined period of time resulting in destruction of any present pathogens by the reverse respiration treatment process in which oxygen is denied to the pathogens during the CO2 phase; and
performing an O2 phase of the reverse respiration treatment process by removing the live plant from the CO2 phase and subjecting the live plant to an oxygenated environment.

23. A method for sterilizing an inorganic object in a safe and effective manner using reverse respiration comprising the step of:
performing a CO2 phase of a reverse respiration treatment process by submerging the inorganic object in a tank that includes a carbonated aqueous solution for a predefined period of time resulting in destruction of any present pathogens by the reverse respiration treatment process in which oxygen is denied to the pathogens during the CO2 phase.

24. The method of claim 23, further including the step of:
performing an O2 phase of the reverse respiration treatment process by removing the inorganic object from the CO2 phase and subjecting the inorganic object to an oxygenated environment.

25. The method of claim 23, further including the step of rinsing the inorganic object after the CO2 phase.

26. The method of claim 23, wherein the inorganic object comprises one of ornaments, rocks, and driftwood.

27. The method of claim 23, including the step of promoting rust retardation and other oxidative attrition by immersed storage in the carboned (CO2) solution.
